(19) United States
(12) Patent Application Publication
(10) Pub. No.: US 2020/0200272 A1
(43) Pub. Date: Jun. 25, 2020

(54) VALVE ASSEMBLY DESIGN USING HYPER-ELASTOMERIC COMPRESSION SYSTEM AND METHOD

(71) Applicant: Oruid USA, LLC, Humble, TX (US)

(72) Inventor: Todd Anthony Travis, Humble, TX (US)

(21) Appl. No.: 16/725,679

(22) Filed: Dec. 23, 2019

Related U.S. Application Data
(60) Provisional application No. 62/783,849, filed on Dec. 21, 2018.

(51) Int. Cl. F16J 15/02; F16K 3/02

(52) U.S. Cl. CPC F16J 15/028; F16J 15/48; F16J 15/022; F16K 3/0227

(57) ABSTRACT

A system and method for utilizing hyper-elastomeric material to create a seal between two surfaces in a valve in order to inhibit the seepage of fluidic material and particles from entering a valve cavity that can damage the assembly. The hyper-elastomeric compression of the hyper-elastomeric material is performed by utilizing hyper-elastomeric compression or a combination of hyper-elastomeric compression and traditional compression methods.

### CROSS-REFERENCE TO RELATED APPLICATIONS

This application claims benefit under 35 U.S.C. § 119 and incorporates by reference U.S. Provisional application for VALVE SEAT ASSEMBLY DESIGN USING HYPER-ELASTOMERIC COMPRESSION by inventor Todd Anthony Travis, filed electronically with the USPTO on Dec. 21, 2018, with Ser. No. 62/783,849, EFS ID 34677480, confirmation number 1177.

### BACKGROUND

### Technical Field

The present disclosure relates to a valve utilized in conventional gate valves, plug valves, and ball valves. More particularly, and not by way of limitation, the present invention utilizes pre-loaded pressure energized elastomeric, non-elastomeric or metallic seals to ensure an airtight and watertight seal between the valve seats or valve body and the gate, ball or plug.

### Description of Related Art

Valve seats have evolved over time from a one-piece radial O-ring sealing design to a two-piece retained face seal design. Following, valve seats evolved even further to a one-piece press-fit design with Teflon face seal and then to a one-piece floating design with spring loaded pressure assist u-cup seals with metal spring back up. The most prevalent existing design today utilizes a single piece seat design with dual inner and outer u-cup spring loaded body to seat seals made of Teflon or other non-elastomeric materials and a hard faced and polished face for the seat to gate seal area. However, the forgoing identified designs have some inherent issues.

First, these valves were not designed or intended for pressure pumping operations such as fracturing. Fracturing operations utilize thousands of barrels of sand and proppant mixed with water and chemicals that flow through the valve at high pressure and in a pulsating pattern. The dimensional tolerances stack-up and mechanical design of the gate, seats, seals and seat pockets are not compatible with pressure pumping and, as a result, inherently flex. The flexing or movements allow debris to seep past the seal areas into the body cavity. This results in damage to the seals, seal areas, and internal parts. The seals typically suffer from low durability, flex, and wear, lasting a meager three months or less when in heavy use before having to be replaced.

The metallic seal areas where seepage and flow occur suffer corrosive pitting and erosion. This can occur within even a few hours. When seepage occurs, damage is accelerated. In normal use, conventional production valves can have a 20-year life span with a maintenance program that includes greasing. Wear on the valve occurs because of the operational pulsing (harmonic) high pressure cycles of pressure pumping (fracking), the media (frac sand and proppant) being pumped (more abrasive and damaging than normal production media of oil and gas), and the increased open and closed gate cycles. These operational characteristics, when occurring over a very short period of time, accelerate seal wear, corrosion, and erosion in the body cavity seal areas making major overhauls, including welding and machining, necessary.

Second, the conventional design inherently pushes the gate, ball or plug against the downstream seat in the closed position and away from the upstream seat. This increases the gap between the gate and upstream seat. Because of the design and position of the seals on the seat, there is a pressure imbalance or differential force created that pushes the upstream seat back into the body pocket. This creates a gap between the gate and the upstream seat, allowing debris to seep past the upstream seat face and the face of the gate. Thus, instead of a pressure assist, the u-cup seals actually have the opposite effect by creating a pressure differential.

Third, the current two seal single piece design does not have sufficient spring force to keep the seat face parallel and in contact with the face to maintain a seal. This spring flex is supposed to allow for movement in the gap between the upstream seat and the body while keeping the face of the seat against the gate and maintaining a seal. However, if the spring force and pressure is insufficient, this can allow debris to migrate into the body cavity and past the seals which can cause damage.

The present invention remedies these problems by maintaining a force capable of sealing off the working pressure while maintaining gate seat contact and seal in high- and low-pressure conditions. The present invention maintains sufficient seal force, reducing or eliminating flex and movement, by combing one or more existing seal design mechanics (compression, squeeze, volume fill, stretch, geometry, and multiple materials) with hyper-compression bridge gaps created by tolerance stack-ups, flex, expansion, and contraction from temperature changes, operations characteristics, and design characteristics.

It would be advantageous to have a system and method for creating a seal in a valve with hyper-elastomeric material through hyper-elastomeric compression that overcomes the disadvantages of the prior art. The present disclosure provides such a system and method

### BRIEF SUMMARY

The present disclosure is of a valve assembly that is part of a gate, plug or ball valve. The valve seat and gate assembly or plug and body create a seal using a hyper-elastomeric material that has been pre-loaded into cavities or pockets in the valve. The hyper-elastomeric material can be pre-loaded through hyper-elastomeric compression exclusively or in combination with traditional compression techniques. Each valve seal area is situated in line with both an inlet and an outlet of a valve. The valve seats are allowed to tilt against a gate, ball or plug so that a seal is created that inhibits fluid and small particles from entering the valve cavity and causing damage to it. In the present design the seats can be eliminated in some cases and the sealing can occur between the gate, plug or ball and body directly.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a side cross sectional view of a gate valve that can be found in the prior art.

FIG. 2 is a side cross section view of a gate valve design having a hyper seal configuration in accordance with an embodiment of the invention.

FIG. 3 is a detailed view of the flow and stack-up gap design of the gate valve of FIG. 2.

FIG. 4A is side cross section view of one embodiment of a hyper seal configuration in a two-piece seat.

FIG. 4B is a side cross section view of a second embodiment of a hyper seal configuration in a three-piece set.

FIG. 4C is a side cross section view of a standard valve seat.

FIG. 5 is a detailed view of a valve seat configured for using a hyper-elastomer seal with anti-extrusion material.

FIG. 6 is a detailed view of a valve seat configuration with integrated hyper-elastomer seal with anti-extrusion.

FIG. 7 is a detailed front view of a seat assembly employing anti-extrusion material in front of the hyper-elastomer seals.

FIGS. 8A and 8B show a side cross section of seals with and without anti-extrusion.

FIG. 9A is a telescoped view of a valve seat configuration using a retainer anti-extrusion material and a hyper-elastomer.

FIG. 9B is a side cross section of a valve seat that houses hyper-elastomeric material to create a hyper seal.

FIG. 10 is a detail view of a valve seat configuration with a retainer anti-extrusion.

FIG. 11A displays a hyper-elastomeric material displayed in isolation.

FIG. 11B displays a hyper-elastomeric material housed in the pocket of a valve seat.

FIG. 11C displays a hyper-elastomeric material housed and compressed into the pocket of a valve seat.

FIG. 12 is a cross-sectional view of a gate valve in accordance with an alternate embodiment of the invention.

FIG. 13 is a cross-sectional view of a gate valve showing a seal in use in a preferred configuration.

FIG. 14 is a cross-sectional close-up view of a gate valve without seats.

FIG. 15 is a cross-sectional close-up view of a ball valve with seats.

FIG. 16 is a cross-sectional close-up view of a ball valve without seats.

FIG. 17 is a cross-sectional close-up view of a plug valve with seats.

FIG. 18 is a cross-sectional close-up view of a plug valve without seats.

### DETAILED DESCRIPTION

All illustrations of the drawings are for the purpose of describing selected version of the present invention and are not intended to limit the scope of the present invention.

Throughout the present patent application, the term hyper-elastomeric material refers to non-metallic material that is intended to experience hyper-elastomeric compression. These materials include but are not limited to Duron®, Polytetraflurothelyene, hyper-elastomeric materials, hyper elastic materials, elastomeric polymers, and other polymer materials. Further, the use of the materials disclosed allows the production of 300,000 lbs. of force against the valves and/or seats disclosed. Furthermore, the valve assembly is predicted to last for twenty-five (25) years in a hostile environment.

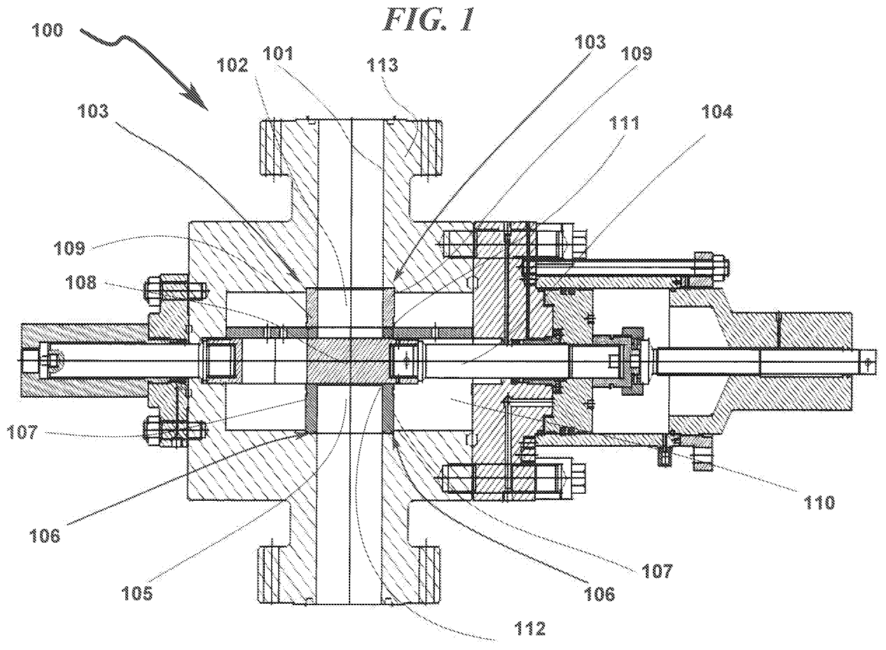

In reference to FIG. 1, the figure is of a gate valve that can be found in the prior art. The gate valve has a flow chamber 101 that allows for a fluidic substance or media such as fluid intermixed with small particulates to flow through a gate valve assembly 100. The flow chamber 101 comprises an inlet 102 and an outlet 105. Upstream body pocket 103 is adjacent to the upstream gate face 111, and downstream body pocket 106 lines the downstream gate face 112. Upstream valve seat 109 is housed in the upstream body pocket 103, with downstream body seat 107 housed in the downstream body pocket 106. The upstream valve seat 109 is adjacent to the inlet 102, and the downstream valve seat 107 is adjacent to the outlet 105. Housed in a body cavity 110 is a gate 108. Both the upstream body pocket 103 and downstream body pocket 106 allow for the upstream valve seat 109 and the downstream valve seat 107 to be positioned inside the valve body 113.

The gate 108 is connected to a stem 104, and the gate 108 is capable of being migrated into the flow chamber 101 so that a fluidic substance that was passing through the flow chamber 101 would be interrupted. Note that the means for migrating the gate 108 can vary depending on the needs of the user and various means are known to one of ordinary skill in the art. Further, the upstream gate face 111 and the downstream gate face 112 are parallel to each other. The gate 108 seals in the fully open and fully closed position. The upstream valve seat 109 and the downstream valve seat 107 enable a tight fit between the flow chamber 101, gate 108, and the valve body 113.

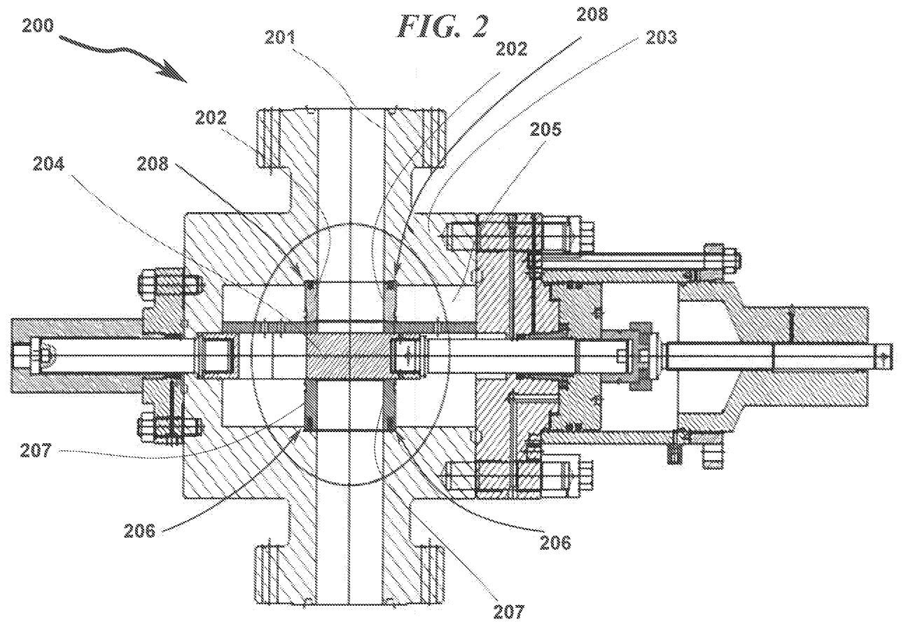

Regarding FIG. 2, the gate valve assembly 200 can be implemented in fracturing operations requiring a substance or a media comprising sand, water, and chemicals to be pumped through the flow chamber 201 into a well which must be capable of sealing during pressure pumping as set out by industry standards prevalent in the relevant arts. Once the substance or media is pumped into the well, it creates fractures in the oil and gas reservoir. The sand and chemicals are injected into the fractures, and this prevents the fractures from closing which, in turn, allows trapped natural gas and other hydrocarbons to flow more easily into the wellbore.

When the pumping stops, the flow of the media reverses and travels back up the well. The media is usually pumped down the well at a higher pressure than the normal production pressure which can reach magnitudes of up to twenty times higher than normal. When pressure pumping is finished, some of the pumped fluids are recovered and hydrocarbons are produced up the well at substantially lower pressures. The hydrocarbons produced were embedded in the oil and gas reservoir and are released when the pressure pumping creates fractures. Some of the sand, water, and chemicals are left down hole in the cracks in the earth as a filter.

The upstream valve seat 202 is positioned in the upstream body pocket 208 to create a seal with the body cavity 205, the gate 204, the valve body 203. Similarly, the downstream valve seat 207 is positioned in the downstream body pocket 206 to create a seal with the body cavity 205, the gate 204, and the valve body 203. This seal is important because it hinders fluids and small particulates such as sand and proppant from entering the body cavity 205 and causing damage to the gate valve assembly 200.

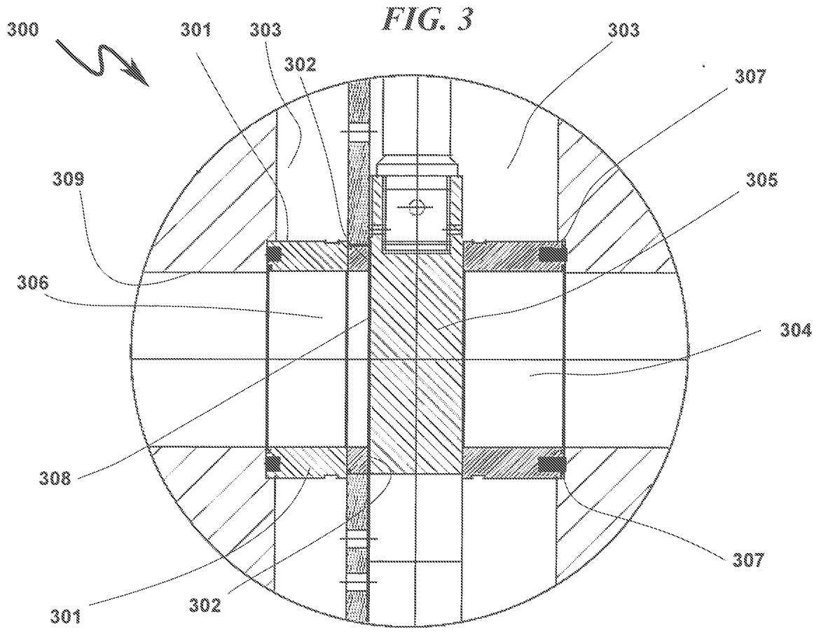

FIG. 3 illustrates the configuration of a two-piece upstream valve seat 301 (Body bushing and seat) adjacent to the inlet 306 and a one-piece downstream valve seat 307 adjacent to the outlet 304. The gate 305 seals in the fully open and fully closed positions against the inner upstream valve seat face 302. The gate 305 is displayed in the closed position. Note the reduction of possible leak paths using the one-piece downstream valve seat 307. Fluid moving through the flow chamber 309 generates immense pressures and pushes the gate 305 away from the upstream valve seat 301, creating a gap between the upstream valve seat 301 and the gate 305. If pressure gets in between the upstream valve seat 301 and the gate 305, the upstream valve seat 301 is unsealed and pushed away from the gate because the force pushing the upstream valve seat 301 is greater than the force on the upstream valve seat 301 from the gate 305 where the seals are located. Therefore, a gap is created, and sand enters the body cavity 303 between the gate 305 and the inner upstream valve seat face 302.

Conventional valves, because of the dimensional tolerance stack-up of the gate, seats, and body pocket, allow sand to seep into the body cavity and damage the internal sealing parts. To prevent this from happening, a pre-loaded, self-aligning, ingress resistant elastomeric seal is fitted concentrically into circular set pockets or cavities on the rear surface of the upstream vale seat, which pushes the upstream valve seat against the migrating gate. This prevents any gaps from forming.

In the present invention, the upstream valve seat 301 and the gate 305 seal along the inner upstream valve seat face 302 and the upstream gate face 308. The two seal surfaces are held parallel to each other and their extreme flatness create the seal. To accomplish this extreme parallelism, the upstream valve seat 301 must be allowed to tilt to keep the surfaces in contact. The upstream valve seat 301 is allowed movement through the nature of squeeze and hyper-elastomeric compression.

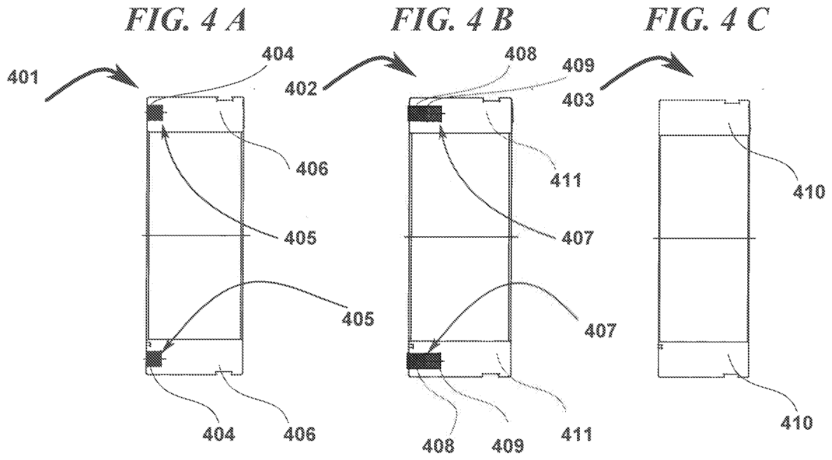

FIG. 4A displays a side cross section of a possible hyper seal configuration in a two-piece seat 401. The hyper-elastomeric material 404 is housed in seat pocket 405, and the seat pocket 405 is housed in seat 406. FIG. 4B also displays a side cross section of a possible hyper seal configuration. However, in FIG. 4B, the valve seat 411 is a three-piece seat 402. The hyper-elastomeric material 409 is housed in seat pocket 407. In addition, an anti-extrusion ring 408 is housed in the seat pocket 407 along with the hyper-elastomeric material 409. Conversely, FIG. 4C displays a stand seat configuration that does not include a pocket to house hyper-elastomeric material for creating a seal. Only the seat 410 is present in FIG. 4C.

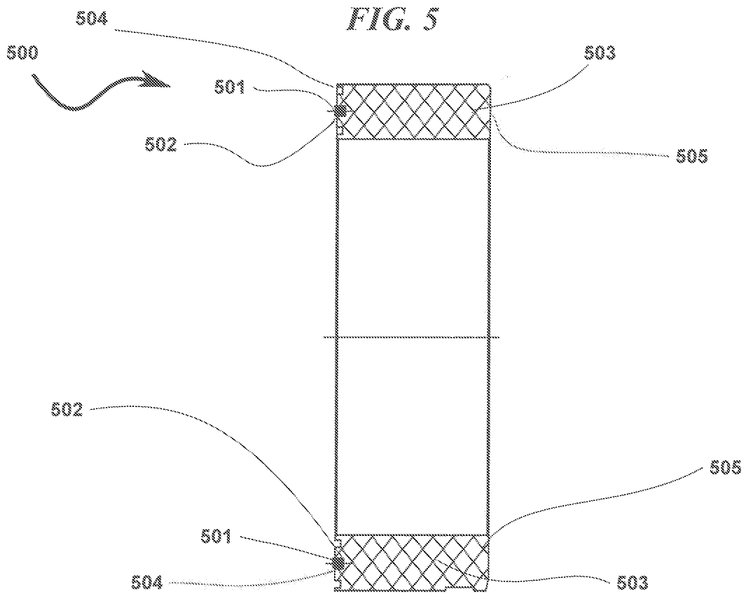

In FIG. 5, the upstream valve seat system 500 has upstream valve seat 503. Each upstream valve seat 503 has an outer upstream valve seat face 504 which is on the opposite side from and parallel with the inner upstream valve seat face 505. The embodiment in FIG. 5 illustrates that upstream seat pockets 502 can be located along the outer upstream valve seat face 504. The seat pocket 502 can be filled with pre-loaded hyper-elastomeric material 501. Most people consider fluids and solids in-compressible because of the infinitesimal volume changes after they reach 100% volume fill. However, in the present invention, the compression of just 3-5% can produce the required pre-loads and allow the required seat movement and flex needed to maintain the seal integrity.

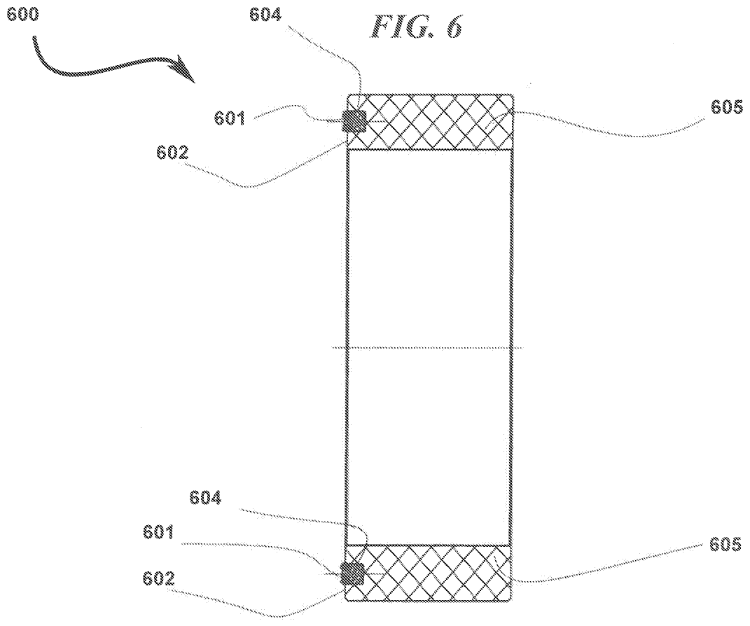

The embodiment of the present invention in FIG. 6 is similar to what is displayed in FIG. 5. The valve seat assembly 600 has valve seat 605. Along the valve seat faces 602, seat pocket 604 house hyper-elastomeric material 601. The hyper-elastomeric material 601 is pre-loaded into the seat pocket 604 through hyper-elastomeric compression. Alternatively, the hyper-elastomeric material can be pre-loaded through a combination of hyper-elastomeric compression and traditional compression methods.

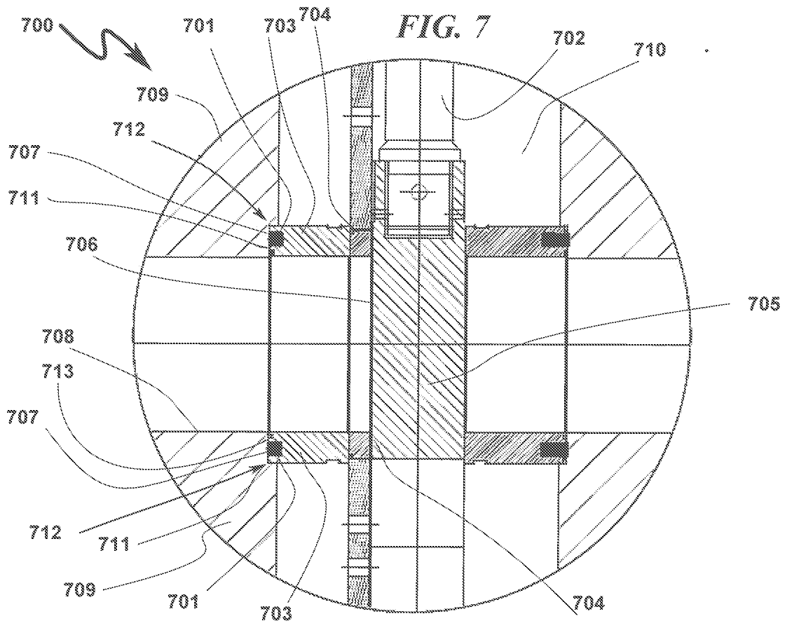

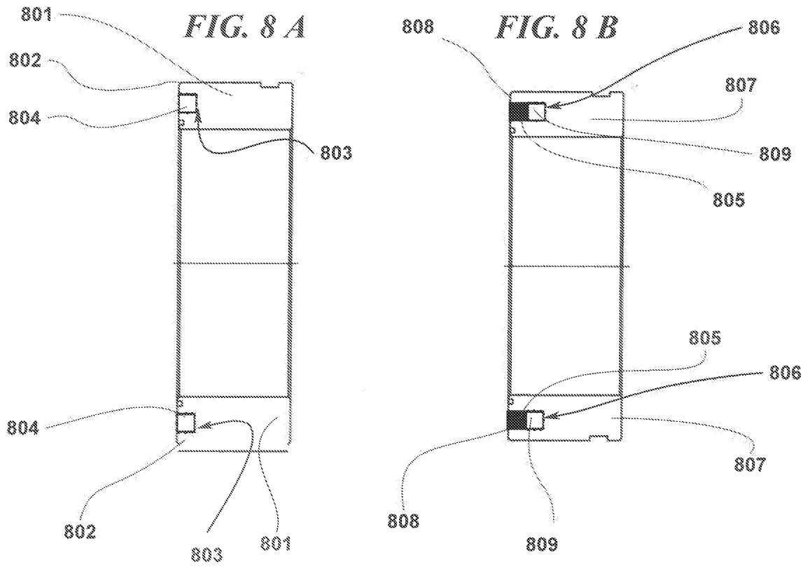

In reference to FIG. 7 and FIG. 8, during normal operation of the present invention, stress far in excess of designed material strengths may force parts of the seat out of the seat pockets (Extrusion). Thus, anti-extrusion rings may be required. These anti-extrusion rings may be molded into the seals or used in addition to hyper-elastomeric seals to prevent and ensure the seals are kept in their proper position and do not extrude. These anti-extrusion rings are typically made of non-elastomeric materials such as PEEK.

Many variations in materials and geometry may be used to generate the desired pre-loads, bearing areas, and movement for the required constrains. It is easily conceivable to engineer alternate embodiments of the present invention to solve requirements in production other than gate valves.

FIG. 7 illustrates a close-up view of the present invention. Upstream valve seat 703 has seat pockets 701 which is filled with a hyper-elastomeric material 707 that has been pre-loaded. The upstream valve seat 703 is housed in the upstream body pocket 712. Seat pockets 701 are located along an outer upstream valve seat face 711, and the outer upstream valve seat face 711 is on the opposite side of the upstream valve seat 703 from the inner upstream valve seat face 704. The outer upstream valve seat face 711 is parallel to the inner upstream valve seat face 704 and an upstream gate face 706. Also, the inner upstream valve seat face 704 is adjacent to the upstream gate face 706.

Due to the extreme flatness of the inner upstream valve seat face 704 and the upstream gate face 706, a seal is created between the inner upstream valve seat face 704 and the upstream gate face 706. On the outer upstream valve seat face 711, a seal is also created with the upstream body pocket 712 of the valve body 709 due to the hyper-elastomeric material 707 sealing so that fluid and small particulates such as sand cannot enter the body cavity 710. In addition, the gate 705 can be migrated into position to interrupt the fluid moving through the flow chamber 708 by means of the stem 702.

FIG. 8A is an example of a valve seat 801 that does not include an anti-extrusion ring. The upstream valve seat face 802 has a seat pockets 803 which houses hyper-elastomeric material 804 that has been pre-loaded. By contrast, in FIG. 8B, the extended seat pocket 806 that is housed in valve seat 807 along seat face 808, also have an anti-extrusion ring 805 that is housed along with the hyper elastomeric material 809. The illustrated anti-extrusion ring 805 is displayed adjacent to the hyper elastomeric material 809 housed in the extended seat pockets 806.

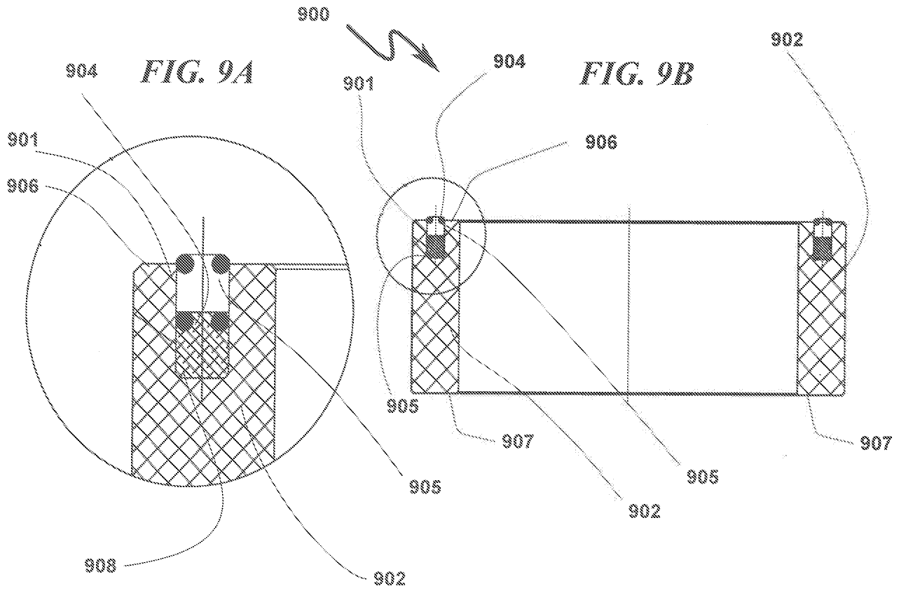

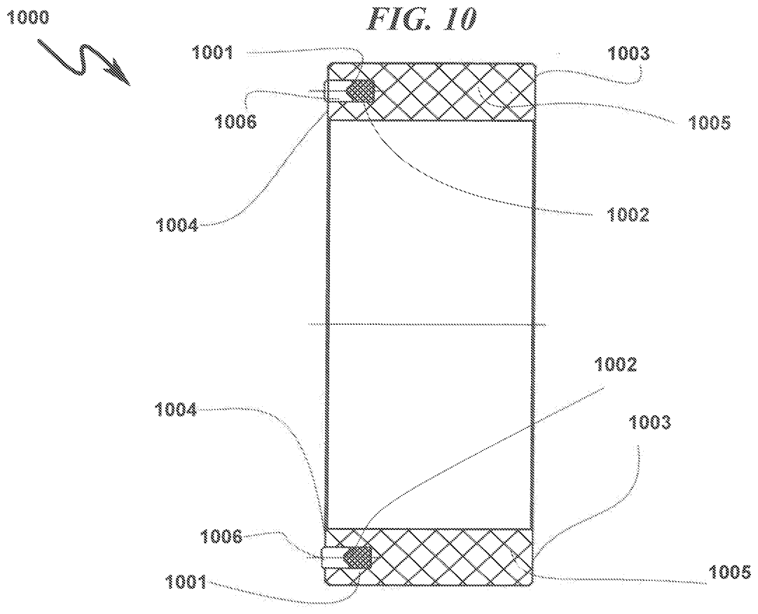

In reference to FIG. 9A, FIG. 9B, and FIG. 10, the valve seats that go into the valve are different from conventional valve seats because the valve seat possesses specific seals which are pre-loaded to hold maximum pressure at installation unlike the conventional seals which are spring loaded for low pressure sealing and utilize conduit pressure assist for higher pressures. The pre-load thickness is calculated prior to manufacturing. The valve seat seal assembly is then assembled by compressing it to the required minimum spring force, and the thickness is measured for compliance to design tolerances. The seat pockets are machined to the tolerance depth and face-to-face width needed to give the required force at the thickness range needed. This ensures proper fit and spring force to the gate during operations. The installation of the valve seat assemblies into the valve is also customized. The valve seats are installed in their body pockets in the valve body with a jacking or pressing tool that creates 400,000 lbs. of pressure, creating the seat to body seal. Then the gate is inserted, and the jacking tool removed. As the jacking tool is removed, the hyper-elastic spring force in the valve seat assemblies expand and presses on the gate creating the seat to gate seal with approximately 300,000 lbs. of force.

FIG. 9A is a telescoped view of the seat pockets 901 of the valve seat assembly 900 in FIG. 9B. The seat pockets 901 reside along the outer upstream valve seat face 906 and is part of upstream valve seat 902. There is an anti-extrusion ring 904 placed adjacent to the hyper-elastomeric material 905. Additionally, both the anti-extrusion ring 904 and the hyper-elastomeric material 905 are housed in the seat pockets 901 of the upstream valve seat 902. The outer upstream valve seat face 906 is parallel to and on the opposite side of the inner upstream gate face 907.

FIG. 10 is a vertical depiction of the upstream valve seat assembly 1000. Valve pocket 1001 is located along the outer upstream valve seat face 1004. The outer upstream valve seat face is parallel to the inner upstream valve seat face 1003 and on the opposite side of the upstream valve seat 1005 from the inner upstream valve seat face 1003. Housed in the seat pocket 1001 is the hyper-elastomeric material 1002 along with anti-extrusion ring 1006. In the illustrated embodiment, the hyper-elastomeric material 1002 is a hypo-elastomer and the anti-extrusion ring 1006 is molded to the hyper-elastomeric material 1002.

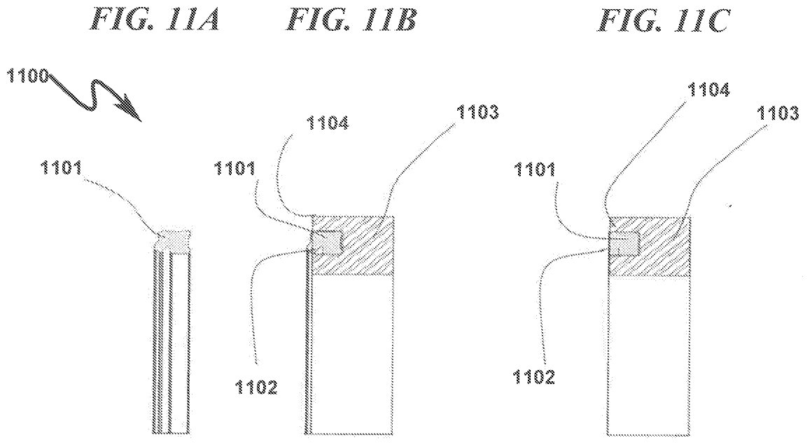

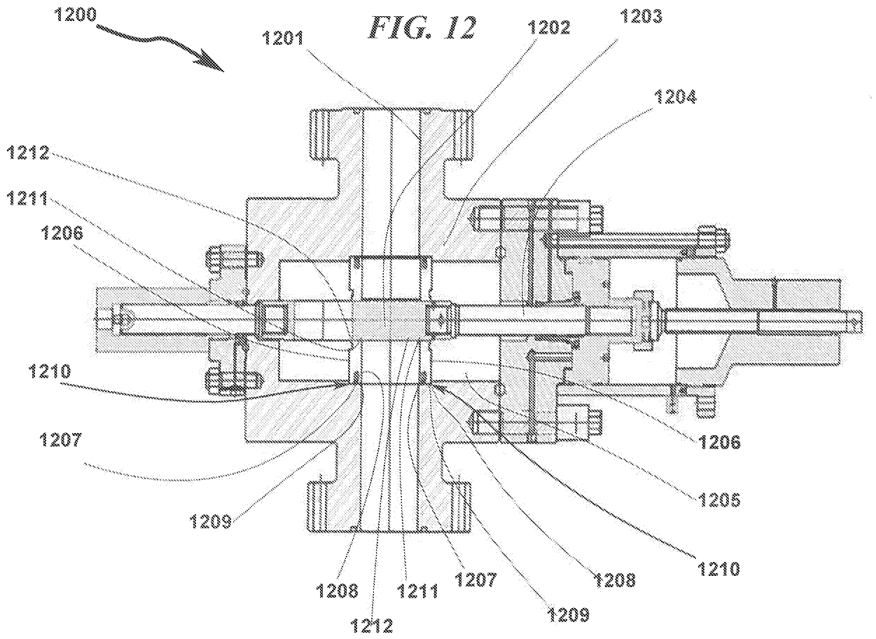

In reference to FIG. 11A, FIG. 11B, FIG. 11C, and FIG. 12, the present invention includes various methods of installation. The overall method of installation involves the seal to be designed to incorporate the seal's elastomeric properties to deform to fill a grooved volumetric space within a given movement range. The seal's geometry resists extrusion within that given movement range and transitions into Hyper-elastomeric compression during the given movement to facilitate a seal force needed to seal a given pressure within the movement range. The hyper-elastomeric compression offers compression with retained memory (pre-load). This is accomplished by reduction of area but with memory to return to the original size. The seal is designed to completely fill the gland groove and compress to a desired stand-off above the gland face (seat) at or above a desired force.

The hyper elastic compression rate of the non-metallic seal material, the allowable movement due to tolerances, and the operations deflections allow for pressure assist features to be incorporated into the design of the present invention to maintain the elastomeric and hyper-elastic functions. The present invention may be used to enhance existing seals in radial or facial applications, as well as bearing press fit applications. The seal provides a continuous sealing force during operation from the hyper-elastic memory and can be augmented by engineering geometry to pressure assist and conventional elastomeric properties such as a squeeze, volume fill, and stretch. The overall method utilizes aspects from traditional methods in conjunction with hyper-elastic materials to generate energizing forces (pre-loads) to enhance traditional seal characteristics.

The seal installation method is primarily for fracturing during short periods of time such as six months but can be engineered to replace existing seal technology. Further, the invention can be engineered to meet the industry twenty-year life cycle requirements. Traditional sealing methods are intentionally NOT designed for 100 percent volume fill. The present invention utilizes traditional sealing methods and incorporates hyper-elastomeric compression, beyond 100 percent volume fill, to form a pre-loaded seal.

One installation method includes the use of a traditional elastomeric sealing composition combined with hyper-elastomeric compression. This method of the present invention forms the seal being squeezed for an interference fit. Following, the hyper-elastomeric compression allows the seal invention to generate additional force to completely seal volumes of high pressure, to generate smaller extrusion gaps, and to reduce dependence of pressure assist.

The seal must be squeezed together by the valve seats and the valve body. As mentioned previously, a jack or similar item may be used for the compression of the seals. Another custom tool, a puller, can be used on the flanges and through the conduit ends. In addition, the puller can utilize the bolts on the flanged ends to pull the seat and squeeze the seal. The gate could then be lowered in between the seats, and the puller is then removed. The seal must be compressed into the hyper-elastomeric compression phase during this installation. Once the gate is in place, the compressed seats and seals can be released. The compression force will reduce as the seals expand. However, the seals will not fully expand because the seat face will come in contact with the gate, halting the expansion of the seals. The gate will float as the pressure from both seats center it in a balance force array. With the seals compressed to the required dimensions and tolerance, the required force (contact stress) is generated between the seat faces and the gate. The seats are allowed to float (move) to keep the faces in contact and parallel.

In the closed position, the gate is pushed against the down-stream seat due to a pressure differential. This compresses the hyper-elastomeric seal assembly further until the seat and body touch. This is the maximum compression of the hyper-elastomeric seal assemble. As the gate moves away from the up-stream seat, the hyper-elastomeric seat expand to take up the available volume change. However, we have calculated the force needed to maintain a seal at maximum working pressure, and the hyper-elastomeric seal assembly does not expand beyond this calculated volume. As a result, the seal keeps the required sealing force needed. When the gate valve is operated, the valve seats continue to push the surfaces up against the gate while it transverses, and the compressed seal prevent any leakage.

A second installation method includes the use of hyper-elastomeric compression to seal over pitted, scared, or worn surfaces. The seal may be used to fill the voids or gaps in used equipment for a compete sealing and to prevent any leakage. A third installation method includes using traditional lip seal methodology with the addition of hyper-elastomeric compression incorporating hyper-elastic spring rates. The seal may combine a traditional lip seal method with hyper-elastomeric compression. The composition works together to produce a better seal, reducing and preventing problems with traditional lip seals.

FIG. 11A, FIG. 11B, and FIG. 11C all display the hyper-elastomeric seal assembly. Starting with FIG. 11A, the hyper-elastomeric seal 1101 is displayed. FIG. 11B illustrates the hyper-elastomeric seal 1101 installed in the seat pocket 1102 which is located along the outer valve seat face 1104 of valve seat 1103. Regarding FIG. 11C, the image is the same as what appears in FIG. 11B, except for the fact that the hyper-elastomeric seal has now been compressed into the seat pocket 1102. In one embodiment, the hyper-elastomeric seal 1101 is compressed utilizing the hyper-elastomeric compression method. As discusses above, there are various other methods that can be utilized to compress the hyper-elastomeric material.

FIG. 12 displays an alternate embodiment of the gate valve assembly 1200 in which the downstream seat 1206 also has hyper-elastomeric material 1207 housed in downstream seat pocket 1208 which is located along an outer downstream valve seat face 1209. The downstream valve seat 1206 is housed in the downstream body pocket 1210. Parallel to and on the opposite side of the downstream valve seat 1206 is the inner downstream valve seat face 1211. Additionally, the inner downstream valve seat face 1211 is parallel to and adjacent with a downstream gate face 1212. The downstream gate face 1212 is facing the downstream side of the gate 1202 which has the means to be migrated into the flow chamber 1201 in order to hinder a media from traversing therethrough. Also, the means of migrating the gate 1202 includes a stem 1204 that is connected to the gate 1202.

A seal is created on a point where the downstream gate face 1212 and the outer downstream valve seat face 1211 abut due to the extreme flatness of the two faces. In addition, a seal is also created between the outer downstream valve seat face 1209 and the gate body 1203 due to the hyper-elastomeric material 1207 so that fluid and small particulates cannot enter the body cavity 1205 and damage the gate valve assembly 1200.

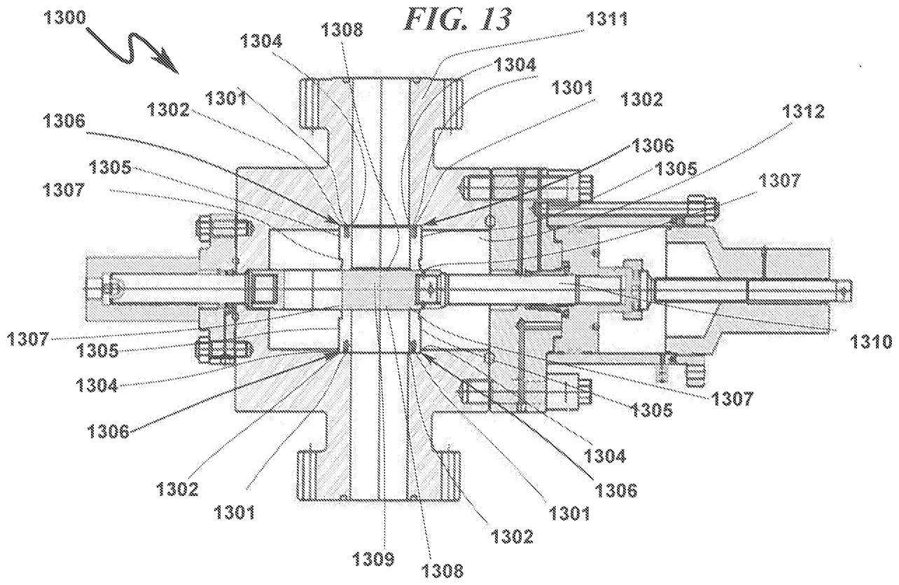

FIG. 13 displays an exemplary embodiment of the gate valve assembly 1300. This embodiment possesses hyper-elastomeric material 1301 which is pre-loaded through hyper-elastomeric compression and housed in seat pockets 1302 which are located on the outer valve seat faces 1304 of valve seats 1305. The valve seats 1305 are housed in valve body pockets 1306. Each outer valve seat face 1304 is situated on the opposite side of its particular valve seat 1305 from an inner valve seat face 1307. The inner valve seat face 1307 is adjacent to a gate face 1308. Furthermore, each inner valve seat face 1307 is parallel with the gate face 1308 and the outer valve seat face 1304. Each gate face resides along the surface of a gate 1309.

The gate 1309 can be migrated into an open or closed position by means of a stem 1310. Hyper-elastomeric material 1301 is used to create a seal with the valve body 1311 and the valve seats 1305 so that harmful material will not penetrate into the body cavity 1312 and induce harm to the gate valve assembly 1300. Another seal is created along each inner valve seat face 1307 and each gate face 1308 due to the extreme flatness of the inner valve seat face 1307 against the gate face 1308 due, in part, to the fact that each valve seat is allowed to tilt against the gate 1309.

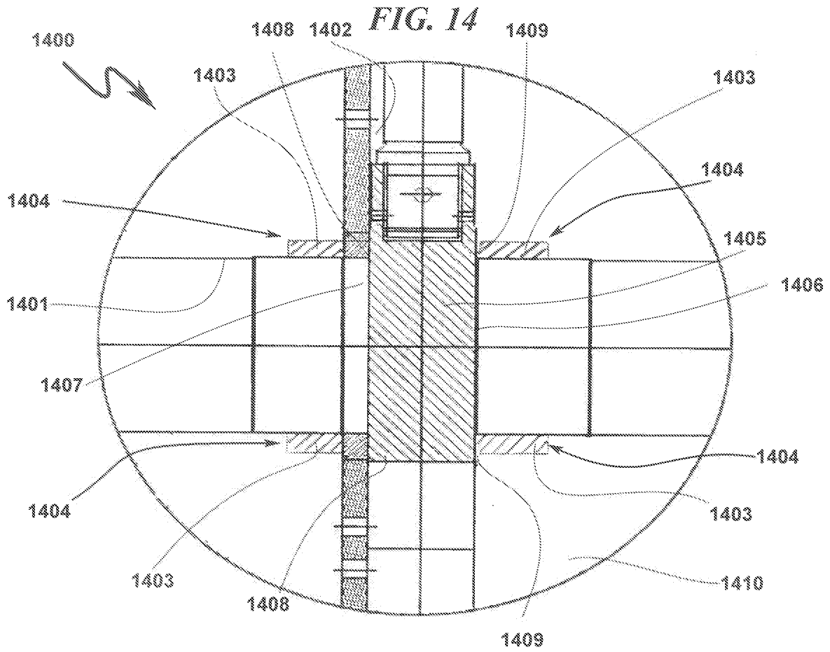

FIG. 14 is a cross-section view of a gate valve assembly 1400 without a seat in accordance with an alternate embodiment of the invention. A hyper-elastomeric material 1403 is compressed and pre-loaded into valve pocket 1404 in the valve body 1410. Rather than a seat forming the seal with the upstream gate face 1407 and the downstream gate face 1406, the hyper-elastomeric material insert 1403 contacts the upstream gate face 1407 and the downstream gate face 1406 directly to form the seal. Like prior embodiments, the hyper-elastomeric material insert 1403 can be sized and compressed to provide approximately 300,000 lbs. of force. The valve pockets 1404 are located adjacent to an upstream gate face 1407 and a downstream gate face 1406. The gate 1405 is designed to intrude into the flow chamber 1401 to interrupt the flow of a substance such as a mixture of water and proppant therethrough. A seal is created between the upstream gate face 1407 and the upstream valve face 1408 and between the downstream gate face 1406 and the downstream valve face 1409. This is due to the hyper-elastomeric material 1403 that has been inserted into the valve pockets 1404 applying pressure to the upstream valve face 1407 and the downstream valve face 1406 to squeeze the sealing surfaces together. In turn, harmful liquid and debris are kept out of the body cavity 1402.

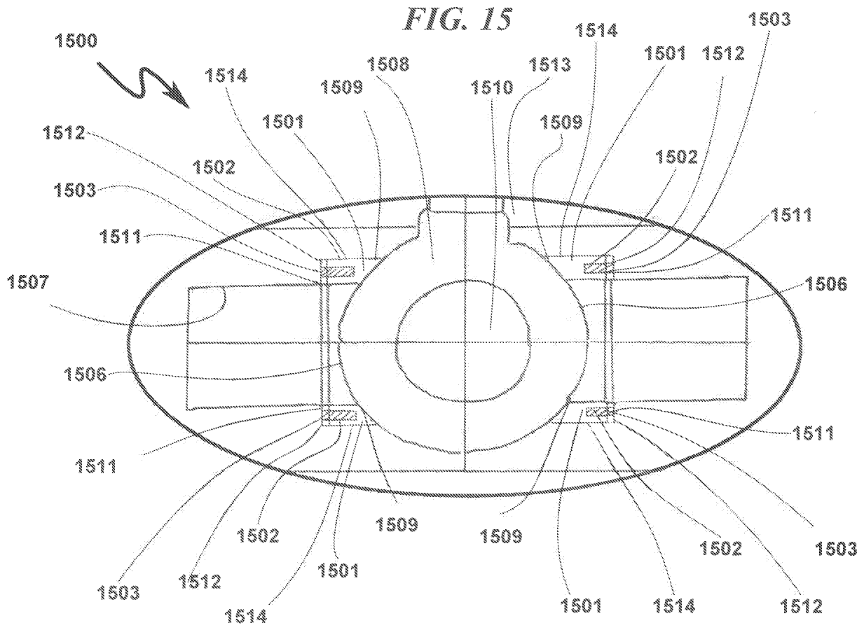

FIG. 15 is a cross-section view of a ball valve assembly 1500 with valve seats in accordance with an alternate embodiment of the invention. Valve seats 1501 are housed in valve body pockets 1514. In addition, the valve seats 1501 are located on both sides of the ball valve 1508 and housed adjacent to the ball valve 1508. The ball valve 1508 has a center aperture 1510 that, when oriented, allows for substances to travel through the flow chamber 1507. Hyper-elastomeric material 1503 is pre-loaded into seat pockets 1502. The seat pockets are positioned on the outer valve face 1511 such that they are adjacent to the valve body face 1512. A seal is created between the inner valve seat face 1509 and the ball valve face 1506. The seal is created by compressing the hyper-elastomeric material such that when energized (pre-loaded), the hyper-elastomeric material 1503 exerts pressure against the valve body face 1512 and the valve seat 1501. That pressure reaches approximately 300,000 lbs. by using an appropriate compression method. The valve seats 1501 are pressed against the ball valve face 1506 to create the seal keeping debris out of the body cavity 1513.

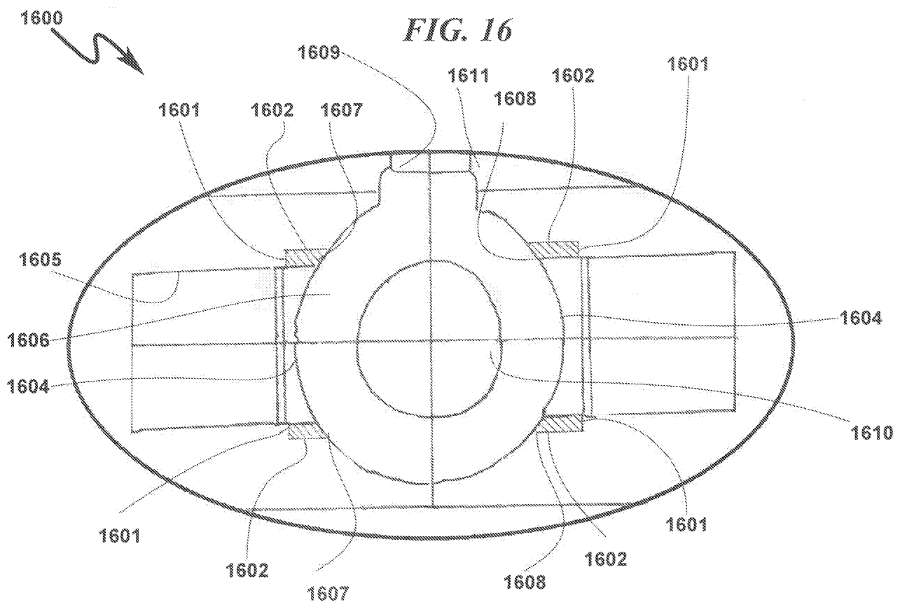

FIG. 16 is a cross-section view of a ball valve assembly 1600 without valve seats in accordance with an alternate embodiment of the invention. The hyper-elastomeric material 1601 is housed and pre-loaded into valve pockets 1602. The hyper-elastomeric material is compressed to provide approximately 300,000 lbs. of force. Additionally, the hyper-elastomeric material 1601 can be compressed through a variety of methods including but not limited to hyper-elastomeric compression and a mixture of hyper-elastomeric compression with traditional elastomeric compression. As a result, the hyper-elastomeric material 1601 presses against the ball face 1604. Due the resulting pressure, a seal is created between the inner valve body face 1607 and the ball face 1604, as well as between the outer valve body face 1608 and the ball face 1604. When the seals are created, substances and particles are inhibited from entering and damaging the body cavity 1611. The ball valve 1606 is capable of being reoriented by the means of a stem 1609 which opens or closes the center aperture 1610. Consequently, the flow of a substance through a flow chamber 1605 is modified depending on whether the center aperture 1610 is in the open or closed position.

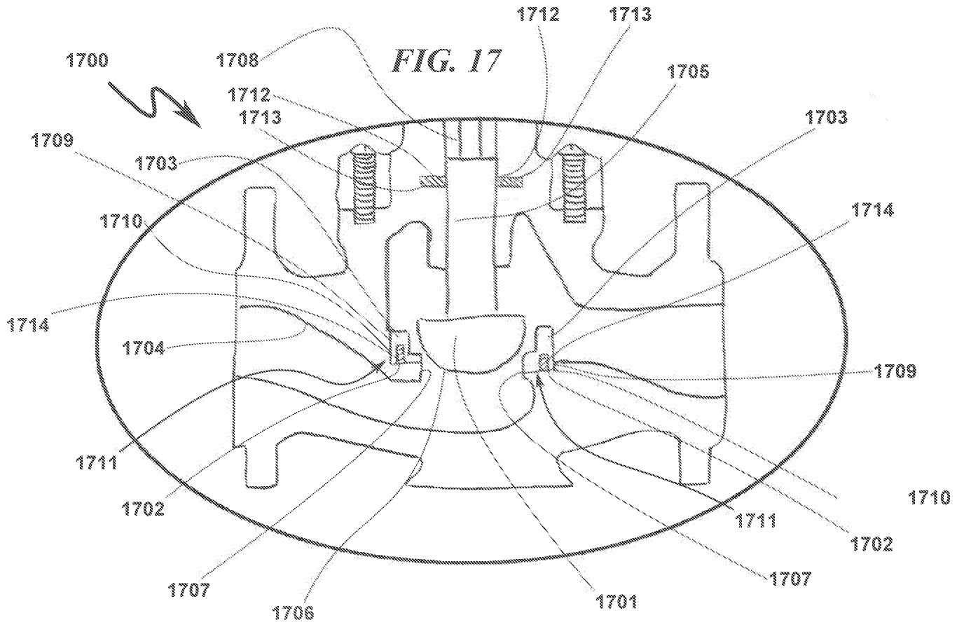

FIG. 17 is a cross-section view of a plug valve assembly 1700 with valve seats in accordance with an alternate embodiment of the invention. The valve seat 1703 is housed in body pocket 1711. The plug 1701 is designed to be inserted by the stem 1705 into the valve seat 1703 until the plug face 1706 engages the inner seat face 1707. Hyper-elastomeric material insert 1702 has been inserted into seat pockets 1714. By pre-loading the hyper-elastomeric material inserts 1702, the material is energized. Pre-loading is accomplished by a wide variety of methods such as hyper-elastomeric compression or a mixture of hyper-elastomeric compression with traditional elastomeric compression. The compression of the hyper-elastomeric material insert 1702 in the seat pocket 1714 creates approximately 300,000 lbs. of force. As a result of the plug 1701 being pressed into the valve seat 1703, a seal is created between the valve seat 1703 and the plug face 1706. This seal is created by the pressure from the hyper-elastomeric material insert 1702 pushing against the valve body face 1710. Once the plug 1701 is secured against the valve seat 1703, the plug 1701 impedes the passage of substances through the flow chamber 1704. A seal is also created along an outer seat face 1709 and valve body face 1710. Once the seal is created, debris is inhibited from entering the body cavity 1708.

In addition, second hyper-elastomeric material insert 1712 has been located in stem pocket 1713. The second hyper-elastomeric material is designed to fit around the stem 1705 like a ring. The inner diameter of the hyper-elastomeric material insert 1712 is slightly larger than the outer diameter of the stem 1705. By compressing the hyper-elastomeric material insert 1712 into the stem pocket 1713, the hyper-elastomeric material insert 1712 pushes against the steam 1705. As a result, an additional seal is created on the stem 1705, keeping debris out of the body cavity 1708.

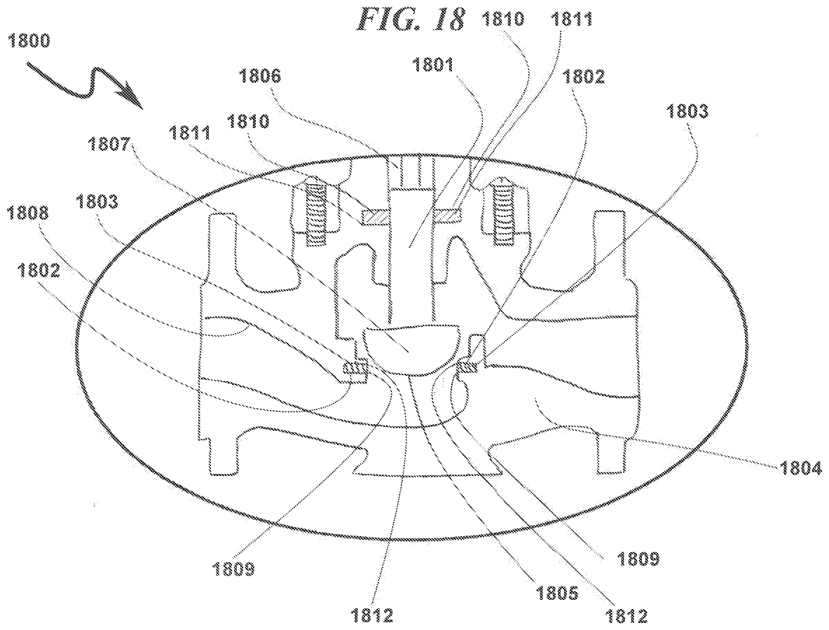

FIG. 18 is a cross-section view of the plug valve assembly 1800 without valve seats in accordance with an alternate embodiment of the invention. The hyper-elastomeric material 1802 is inserted into the valve pockets 1803 by a compression method such as hyper-elastomeric compression and a mixture of hyper-elastomeric compression. Once the hyper-elastomeric material 1802 has been pre-loaded, the compressed material exerts approximately 300,000 lbs. of force. When the plug valve assembly 1800 is in the open position, substance such as water and proppant are allowed to move through a flow chamber 1808. However, a plug 1807 can be migrated downward by a stem 1801 until a valve body surface 1812 engages with the plug face 1805. As a result, the plug valve assembly 1800 is in the closed position. Once valve body surface 1812 is positioned adjacent to the plug valve face 1805, the hyper-elastomeric material presses against the plug valve face 1805. A seal is created along the plug valve face 1805 and the valve body face 1809 of the valve body 1804 due to the pressure from the hyper-elastomeric material pressing against the plug 1807. The result is that the liquid and proppant are no longer able to travel through the flow chamber 1808. Further, fluid and particulates are prevented from entering the body cavity 1806 so that damage and wear and tear to the plug valve assembly 1800 is limited.

In addition, second hyper-elastomeric material insert 1810 has been located in stem pocket 1811. The second hyper-elastomeric material is designed to fit around the stem 1801 like a ring. The inner diameter of the hyper-elastomeric material insert 1810 is slightly larger than the outer diameter of the stem 1801. By compressing the hyper-elastomeric material insert 1810 into the stem pocket 1811, the hyper-elastomeric material insert 1810 pushes against the stem 1801. As a result, an additional seal is created on the stem 1801, keeping debris out of the body cavity 1806.

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called filed. Further, a description of a technology as background information is not to be construed as an admission that certain technology is prior art to any embodiments) in this disclosure. Neither is the “Brief Summary” to be considered as a characterization of the embodiments(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of the such claims shall be considered on their own merits in light of this disclosure but should not be constrained by the headings set forth herein.

We claim:

1. A valve assembly comprising:
a valve seat, the valve seat having a seat pocket, the seat pocket housing a hyper-elastomeric material insert configured to apply pressure to the valve seat to press the valve seat against a valve face of a valve.

2. The valve assembly of claim 1 further comprising:
a body pocket housing the valve seat, wherein an outer valve seat face is positioned on the opposite side of the valve seat from an inner valve seat face, and wherein the inner valve seat face is adjacent to the valve face of the valve; and
the inner valve seat face configured to seal against the valve face.

3. The valve assembly of claim 1, wherein the valve is selected from a group consisting of:
a gate valve, a plug valve, and a ball valve.

4. The valve assembly of claim 1, wherein the hyper-elastomeric material is pre-loaded into the seat pocket.

5. The valve assembly of claim 4, wherein the hyper-elastomeric material is pre-loaded into the seat pocket utilizing hyper-elastomeric compression.

6. The valve assembly of claim 4, wherein the hyper-elastomeric material is pre-loaded into the seat pocket utilizing a combination of traditional elastomeric compression and hyper-elastomeric compression.

7. The valve assembly of claim 1, wherein the valve seat is allowed to tilt against the valve face.

8. The valve assembly of claim 1, wherein the valve is configured to seal in an open flow position and a closed flow position.

9. The valve assembly of claim 1, wherein the seat pocket further comprises at least one anti-extrusion ring.

10. A valve assembly comprising:
a valve having a valve face;
a valve body having a valve pocket, wherein the valve body is located adjacent to the valve face;
a compressed hyper-elastomeric material insert housed in the valve pocket, wherein the hyper-elastomeric material insert is configured to apply pressure against the valve face to create a seal.

11. The valve assembly of claim 10, wherein the valve is selected from a group consisting of:
a gate valve, a plug valve, and a ball valve.

12. The valve assembly of claim 10, wherein the hyper-elastomeric material is pre-loaded into the valve pocket.

13. The valve assembly of claim 10, wherein the hyper-elastomeric material is pre-loaded into the valve pocket utilizing hyper-elastomeric compression.

14. The valve assembly of claim 10, wherein the hyper-elastomeric material is pre-loaded into the valve pocket utilizing a combination of traditional elastomeric compression and hyper-elastomeric compression.

15. The valve assembly of claim 10, wherein the valve is configured to seal in an open flow position and a closed flow position.

16. The valve assembly of claim 10, wherein the valve pocket further comprising at least one anti-extrusion ring.

17. A sealing method for use with a valve assembly comprising:
housing a compressed hyper-elastomeric material insert in a body pocket; and
creating a seal with the hyper-elastomeric material insert by applying pressure against a valve face of a valve.

18. The sealing method of claim 17 further comprising:
housing the body pocket in a valve seat;
housing the valve seat in a valve pocket, wherein the valve seat is located adjacent to the valve.

19. The sealing method of claim 17 further comprising:
housing the body pocket in a valve body; wherein the body pocket is located adjacent to the valve face of the valve.

20. The sealing method of claim 17, wherein the valve is selected from a group consisting of:
a gate valve, a plug valve, and a ball valve.

21. The sealing method of claim 17, wherein the hyper-elastomeric material is pre-loaded into the body pocket.

22. The sealing method of claim 21 further comprising:
utilizing hyper-elastomeric compression to pre-load the hyper-elastomeric material into the body pocket.

23. The sealing method of claim 21 further comprising:
utilizing a combination of traditional elastomeric compression and hyper-elastomeric compression to pre-load the hyper-elastomeric material into the body pocket.

24. The sealing method of claim 17, wherein the body pocket further comprising at least one anti-extrusion ring.

25. The sealing method of claim 17, wherein the valve is configured to seal in an open flow and a closed flow position.
